(19) United States
(12) Patent Application Publication
(10) Pub. No.: US 2005/0218015 A1
(43) Pub. Date: Oct. 6, 2005

(54) Universal bottle cap

(76) Inventor: Donald Spector, New York, NY (US)

Correspondence Address: Glen M. Diehl;NORTON & DIEHL LLC, Suite 110, 77 Brant Avenue, Clark, NJ, 07066, US

(21) Appl. No.: 11/135,734

(22) Filed: May 24, 2005

Related U.S. Application Data
(63) Continuation-in-part of application No. 10/943,712, filed on Sep. 17, 2004.
Application No. 10/943,712 is a continuation-in-part of application No. 10/463,927, filed on Jun. 18, 2003, now Pat. No. 6,820,740.

(51) Int. Cl. B67D 5/00

(52) U.S. Cl. 206/222

(57) ABSTRACT

A bottle cap for universal retrofitting to one of a number of pre-existing beverage containers containing a beverage and having a removed cap and threaded aperture, having at least one container portion for containing at least one dispensable material, a threaded portion for receiving the threaded aperture and creating, when threaded, a water-tight assembly; and a bag containing the dispensable material located in the container portion. Upon screwable attachment of the threaded aperture into the cap, the threaded aperture parses at least a portion of the bag to permit feeding of the material into the beverage. A plurality of such caps is also shown packaged for commercial sale. The material contained in the cap is selected from the group consisting of vitamins, medicaments, teas, flavors, concentrates and water-soluble food material. Also shown is a universal cap further having a moveable aperture assembly creating an open, fluid-flowing state and a closed, fluid-stopped state, having a top portion containing a drinking aperture and an elongated, moveable fluid-flowing portion.

### CROSS-REFERENCE TO RELATED APPLICATIONS

This is a continuation-in-part of co-pending U.S. patent application Ser. No. 10/943,712, filed on Sep. 17, 2004, which is a continuation-in-part of U.S. patent application Ser. No. 10/463,927, filed on Jun. 18, 2003, now U.S. Pat. No. 6,820,740, the disclosures of which are herein fully incorporated by reference.

### BACKGOUND OF THE INVENTION

The present invention relates to the field of beverages, dispensing materials into a container containing a fluid, and more specifically to beverages and fluids contained in bottles with removal caps, such that a cap can be retrofittedly placed upon the bottle or container, post removal of its originating cap, in a manner that dispenses materials including, e.g., vitamins, flavors and other ingredients, into the beverage or fluid.

The beverage world today is largely possessed by bottled water contained in plastic bottles having virtually identical removable caps. Such caps are removed by twistable action, leaving a band or collar behind as the cap is removed, while simultaneously providing access for drinking to the top of the bottle. Beverages also comprise pre-mixed drinks with a plurality of different designs, requiring, among other things, refrigeration, dates of expiration and other indicators related to the shelf-life of the beverage.

Well known in the art are water-soluble drink mixes that are sold in solid form. The consumer measures quantities of the dry material, adds the quantities in the proper ratio to water, and creates a flavored beverage. In these embodiments, the consumer is required to modulate the quantities, and mistakes result in under- or over-flavored mixtures.

It is important to maintain freshness of fluid-based products. This is particularly important when the material to be dispensed is vitamin-based, since it is known that water-miscible vitamins can lose their potency over time when in a fluid environment, through changes in, inter alia, temperature, pressure, and light. In addition, fluid-based products can interact with plastic bottles, causing an unpleasant taste and comprising the health of the user. Glass bottles are thus required, which are more expensive and much heavier.

Heretofore unknown in the art, is a universal cap design that contains dry or concentrated materials including, e.g., vitamins, drink mixes and other flavors, food materials, hygiene materials, medicaments, and non-ingestible materials such as cleaning products, cosmetics, toiletries, art supplies, laboratory chemicals, etc., such that the cap is capable of utilization with any number of fluid containers, predominantly water, without the need for modification of the existing, standard, plastic bottle design. In other words, once the pre-existing cap is removed, the new cap, containing the materials, can be retrofittedly installed upon the bottle top, dispensing the materials into the fluid. The result can be shaken and the completed product created moments before consumption or usage.

Known devices include US. Publication No. 2003/0072850 to Burniski, U.S. Pat. No. 6,098,795 to Mollstram, U.S. Pat. No. 5,772,017 to Kang, U.S. Pat. No. 5,246,142 to DiPalma, and U.S. Pat. No. 2,859,898 to Mendenhall. These devices, however, incorporate convoluted mechanisms that do not permit retrofitting to pre-existing bottle designs, and rather have cumbersome mechanisms for rotation and dispensation. Moreover, from the practical consumer vantage point, at purchase point, both an associated cap and fluid product must be acquired in pre-packaged form. Unknown is the disassociation of the two, permitting the consumer to purchase, independently, caps with a plurality of different materials contained therein, and standard, plastic fluid bottles.

It is thus an object of the instant invention to provide a universal, single-use cap containing materials for attachment to pre-existing fluid containers to permit dispensation of materials.

It is a further object of the instant invention to provide a universal cap in a plurality of different flavors for single-use attachment to pre-existing fluid containers, for simple access by a consumer.

It is a still further object of the instant invention to provide a plurality of universal caps having different materials, like vitamins, contained therein, such that consumers can independently purchase such caps from the decision to purchase their favorite forms of beverages, like water.

It is a still additional and further object of the instant invention to provide a plurality of universal caps having different flavors, like teas, contained therein, such that consumers can have fresh tea products in their favorite form of bottled water.

### SUMMARY OF THE INVENTION

The various features of novelty which characterize the invention are pointed out with particularity in the claims annexed to and forming a part of the disclosure. For a better understanding of the invention, its operating advantages, and specific objects attained by its use, reference should be had to the drawings and descriptive matter in which there are illustrated and described preferred embodiments of the invention.

One or more of the foregoing objects and other objects of the invention are achieved through a bottle cap for universal retrofitting to one of a number of pre-existing beverage or fluid containers containing a beverage or a fluid and having a removed cap and threaded aperture. In general, a majority of water, other beverages and other fluids are or can be packaged in a standard bottle having a removable cap, leaving behind, upon its removal, screw threads. The cap of the subject invention mates with these screw threads to create a water-tight assembly by having a screwable attachment portion for receiving the screw threads of the top of the bottle. Alternatively, the cap can be a plug-type device that is simply pushed into the bottle.

The cap further has at least one container portion for containing at least one dispensable material. In some embodiments, the cap has two or more container portions or chambers for containing separately two or more dispensable materials. The dispensable materials can be released and then mixed into a fluid in a container by simultaneous or sequential dispensation into the fluid. The dispensable material can be selected from the group consisting of vitamins, drink mixes, hygiene materials, such as mouth wash, medicaments, such as pharmaceuticals and nutraceuticals, teas, flavors, concentrates and water-soluble food material, such as infant formula, and non-ingestible materials, such as cleaning products, cosmetics, toiletries, dyes, pigments, and laboratory chemicals, such as salts and buffers. The dispensable material can also include a liquor, more than one liquor and powders, such as a baby formula mix. Thus, the dispensable material can include fluids and powders, and there are many possible ingredients that can be stored in the chambers in the bottle cap for subsequent release into a fluid.

The bottle cap includes a parseable member to create the chamber. In some embodiments, the bottle cap has a parseable membrane substantially planarly located within the plane defined by a cross-section of the screwable attachment portion, such that on said membrane's one surface containment for said container portion is provided, and on its other surface an air barrier to the contained material is provided. Upon screwable attachment of the threaded aperture into the screwable attachment means, the threaded aperture parses at least a portion of the parseable membrane to permit feeding of the material into the fluid. Once parsed, the material freely flows into the fluid, either through gravitational action, shaking, or a combination thereof. Once fed into the fluid, the material disburses, creating a fresh product.

In the case of multiple chambers, another membrane can be provided perpendicularly to the first membrane to provide the separate chambers within the bottle cap. The perpendicularly oriented membranes can be formed integrally with the first membrane that provides a seal between the bottle cap and the outside environment, or the membranes can be held together by an adhesive.

In other embodiments, the dispensable material is located in a sealed bag or packet formed of a parseable membrane material. The bag or packet is located in an upper portion of the cap, positioned across the cap. Upon screwable attachment of the threaded aperture into the screwable attachment means, the threaded aperture parses at least a portion of the bag or packet to permit feeding of the material into the fluid. Once parsed, the material freely flows into the fluid, either through gravitational action, shaking, or a combination thereof. Once fed into the beverage, the material disburses, creating a fresh product. The bag can be mounted to the cap via any suitable means, such as adhesive or a plastic support ring. Because the bag is sealed and self-contained, there is no need to seal the bag in an airtight manner across the cap. Thus, even if some of the adhesive comes loose, the dispensable material is still securely stored within the bag until it is released by the user. The bag or packet is preferably perforated in the areas that are to be opened, to ease the opening of the bag by the user.

In the case where it is desired to provide a plurality of chambers in the bottle cap, a plurality of bags can be provided. The plurality of bags can be located side by side in the bottle cap such that each bag is parsed as the bottle cap is attached to a liquid container.

A plurality of such bottle caps may be packaged for commercial sale. In this manner, for example, different flavors or vitamin compositions are provided, and a consumer can purchase virtually any beverage that has a suitably mating screw thread to the unique cap defined herein. Liquors, cleaning products, baby formula, etc. can also be packaged for commercial sale in this manner.

In another embodiment, the universal cap has a moveable aperture assembly creating an open, fluid-flowing state and a closed, fluid-stopped state (often referred to as a “sports bottle”) having a top portion containing a drinking aperture and an elongated, moveable fluid-flowing portion. In some embodiments, the moveable fluid-flowing portion has a cutting end located adjacent the packet, bag or membrane. The movable portion is initially set into the open, fluid flowing state when the packet is sealed, and then lowered onto the packet, bag or membrane to parse the packet to release the material into the liquid. Again, the packet or bag may be perforated in the areas next to the movable portion to facilitate opening by the moveable portion. After the material is mixed, the moveable aperture portion functions as a valve, allowing the user to move it to opened flowing states or closed states.

There is preferably a removable cap or collar placed over or around the moveable aperture assembly, to prevent premature depression of the aperture assembly during shipping and storage.

In yet another embodiment, the universal bottle cap has a pump assembly comprising an actuator and an elongated, fluid-flowing conduit in fluid communication with the actuator. Upon enabling the actuator, the fluid-flowing conduit transmits fluid to a nozzle so that the fluid is emitted from the pump assembly. The bottle cap includes the sealed chambers to provide ingredients to be released into a fluid container. Pump assemblies are well known and are commonly used for household and automotive cleaners and personal care products, such as hair sprays, perfumes, colognes, and the like. Suitable pump assemblies include trigger sprayers, spray pumps, cream pumps, lotion pumps, nasal sprayers, and perfume atomizers. The use of pump assemblies

Other features of the present invention will become apparent from the following detailed description considered in conjunction with the accompanying drawings. It is to be understood, however, that the drawings are designed solely for purposes of illustration and not as a definition of the limits of the invention, for which reference should be made to the appended claims.

### BRIEF DESCRIPTION OF THE DRAWINGS

Other objects and features of the present invention will become apparent from the following detailed description considered in connection with the accompanying drawings. It is to be understood, however, that the drawings are designed as an illustration only and not as a definition of the limits of the invention. In the drawings, wherein similar reference characters denote similar elements throughout the several views:

FIG. 1 is a perspective view of a bottle cap in accordance with one aspect of the invention.

FIG. 2 is a cross-sectional view of the bottle cap shown in FIG. 1, taken along line A—A shown therein.

FIG. 3 is perspective view of the bottle cap installed upon a bottled beverage container showing the parsing of the membrane and the dispensation of material, in accordance with an aspect the present invention.

FIG. 4 is a perspective view of an alternative bottle cap assembly having lockable fluid-stopped and fluid-flowing states, in accordance with another aspect of the present invention.

FIG. 5 is a perspective view of the alternative bottle cap of FIG. 4, shown attached to a bottle in the fluid-flowing state.

FIG. 6 is a perspective view of a plurality of caps in a consumer saleable package, in accordance with a further aspect of the present invention.

FIG. 7 is a perspective view of a bottle cap in accordance with another aspect of the present invention.

FIG. 8 is a cross-sectional view of the cap shown in FIG. 7, taken along line A-A shown therein.

FIG. 9 is perspective view of a bottle cap installed upon a bottled beverage container showing the parsing of the bag and the dispensation of material, in accordance with a preferred embodiment of the subject invention.

FIG. 10 is a perspective view of an alternative cap assembly having lockable fluid stopped and fluid-flowing states, in accordance with another aspect of the present invention.

FIG. 11 is a perspective view of the alternative cap of FIG. 10, shown attached to a bottle in the fluid-flowing state.

FIG. 12 shows a bottle cap with an integral pump spray mechanism.

FIGS. 13 to 17 show a bottle cap with multiple chambers for dispensing multiple ingredients into a fluid container in accordance with one aspect of the present invention.

FIGS. 17 to 21 show a bottle cap with multiple chambers for dispensing multiple ingredients into a fluid container in accordance with another aspect of the present invention.

### DETAILED DESCRIPTION OF THE PREFERRED EMBODIMENT

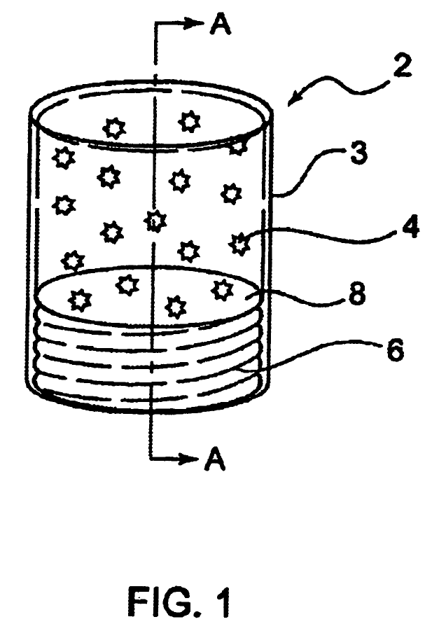

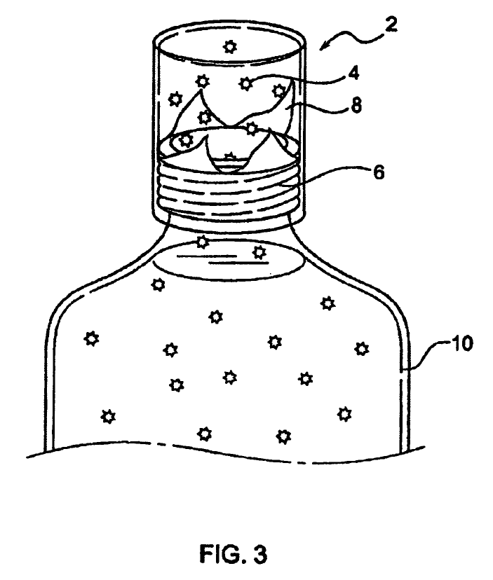

FIG. 1 shows a perspective view of cap 2, having a container portion 3 containing material 4 for dispensation into a beverage, upon attachment. Also shown is a parseable membrane 8 planarly located within the confines of screw thread receiving means 6, for reasons shown and explained in greater detail in connection with FIG. 3.

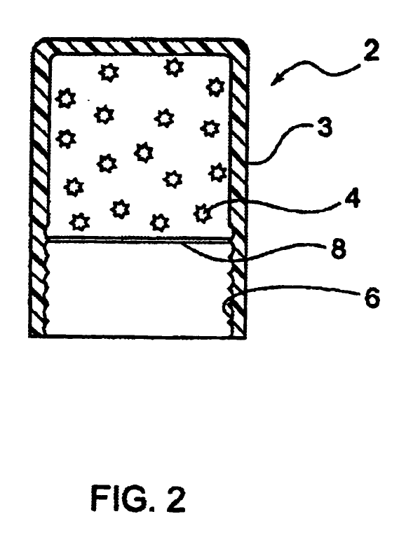

FIG. 2 shows a cross-section of cap 2, shown in FIG. 1, taken along line A—A of FIG. 1, wherein container portion 3 is shown holding material 4, and membrane 8 is shown within the planar region of screw thread receiving means 6.

FIG. 3 reveals the attachment of cap 2 to a bottle 10 containing a beverage, in which the screw threaded upper region of bottle 10 has parsed membrane 8, shown in parsed form therein, permitting material 4 to feed into the beverage. It should be understood that membrane 8 is simply parsed by the effect of screwing the upper threaded region of bottle 10 into the receiving means 6, and that no further action is required.

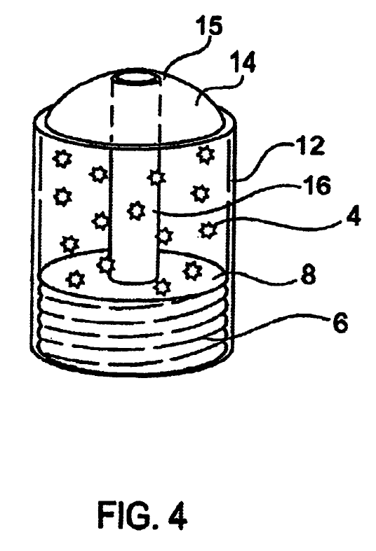

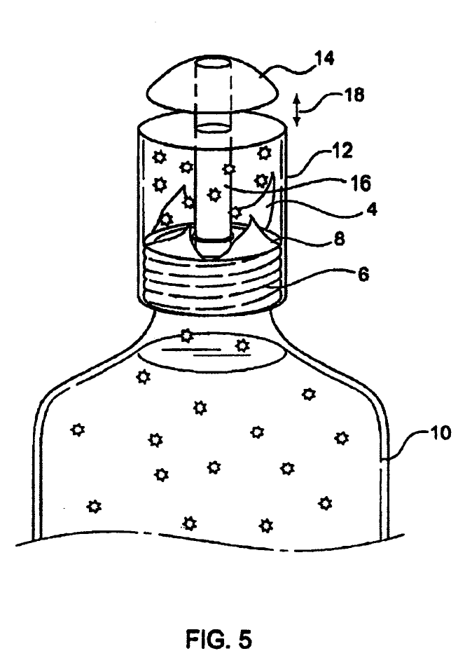

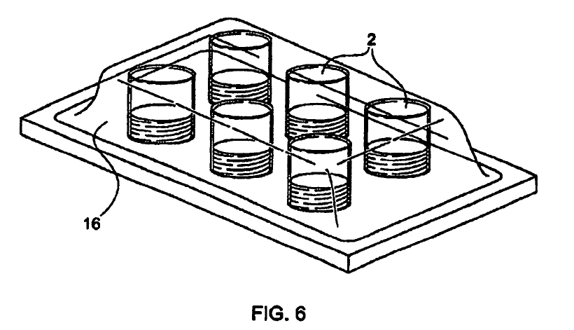

FIG. 4 shows an alternative embodiment of a cap 12, having a moveable aperture assembly 14 creating an open, fluid-flowing state and a closed, fluid-stopped state, having a top portion 15 as a drinking aperture and an elongated, moveable fluid-flowing portion 16 which rides above membrane 8. It should be understood that portion 16 can also attach to membrane 8, such that screwable assembly does not break the membrane but, rather, only movement of assembly 14 breaks the membrane. In the state as shown in FIG. 4, however, the parsing of membrane 8 occurs upon screwable assembly, as shown in FIG. 5, wherein membrane 8 is shown parsed and material 4 is disbursed. Lastly, FIG. 6 shows a multiplicity of caps 2 in a consumer-saleable package design 16.

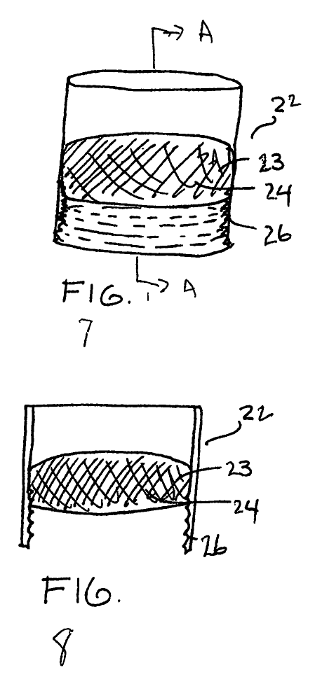

FIG. 7 shows a perspective view of cap 22, having a container portion formed from a bag 23 containing material 24 for dispensation into a beverage, upon attachment. Bag 23 is located above screw threads 26, for reasons shown and explained in greater detail in connection with FIG. 9.

FIG. 8 shows a cross-section of cap 22, shown in FIG. 7, taken along line A-A of FIG. 7, wherein bag 23 is shown holding material 24.

FIG. 9 reveals the attachment of cap 22 to a bottle 30 containing a beverage, in which the screw threaded upper region 31 of bottle 30 has parsed bag 23, shown in parsed form therein, permitting material 24 to feed into the beverage. It should be understood that bag 23 is simply parsed by the effect of screwing the upper threaded region of bottle 30 into the receiving means 26, and that no further action is required. Bag 23 can be perforated to enable easier opening of bag 23.

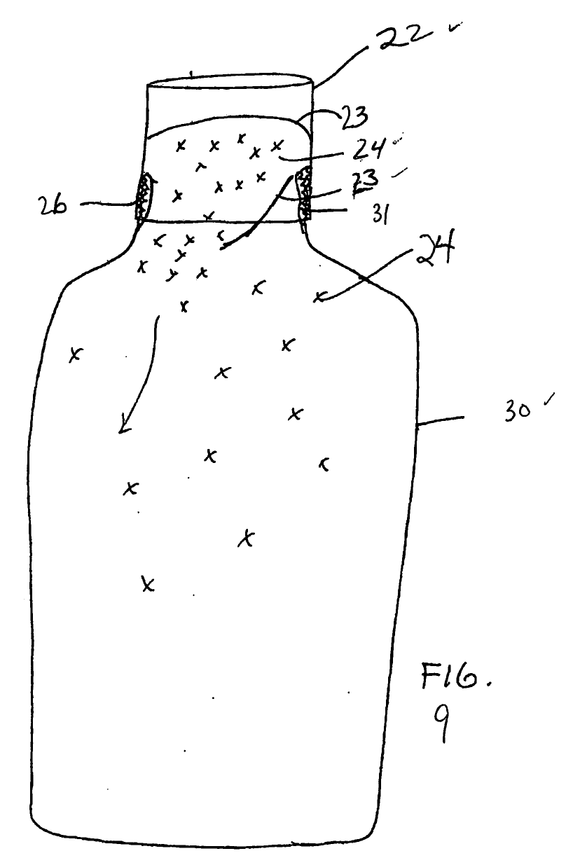

FIG. 10 shows an alternative embodiment of a cap 32, having a moveable aperture assembly 34 creating an open, fluid-flowing state and a closed, fluid-stopped state, having a top portion 35 as a drinking aperture and an elongated, moveable fluid-flowing portion 36 which rides above bag 23. It should be understood that portion 36 can also attach to bag 23, such that screwable assembly does not break the membrane forming bag 33 but, rather, only movement of assembly 34 downward breaks the bag. In use, assembly 34 is initially placed into the opened state, and when mixing of the liquid and material in bag 33 is desired, assembly 34 is depressed until cutting end 40 perforates bag 33, as shown in FIG. 11. Bag 33 has perforations 41 to facilitate the perforation of bag 33. Ingredients 37 are released from the bag 33 into the fluid container.

Bag 33 can be held in place by plastic ring 42, or by any other method, such as by adhesive.

Preferably, a cap 50 is removably placed over assembly 34, to prevent inadvertent depression of assembly 34, which would prematurely perforate bag 33. Cap 50 could also be in the form of an open-topped collar.

In yet an alternative embodiment the cap could be in the form of a plug that is press-fit into the bottle opening, or could be in the form of a cap that is press-fit around the outer rim of the bottle opening, thus not requiring any threads to keep it in place. Any other suitable means for attaching the cap could also be used.

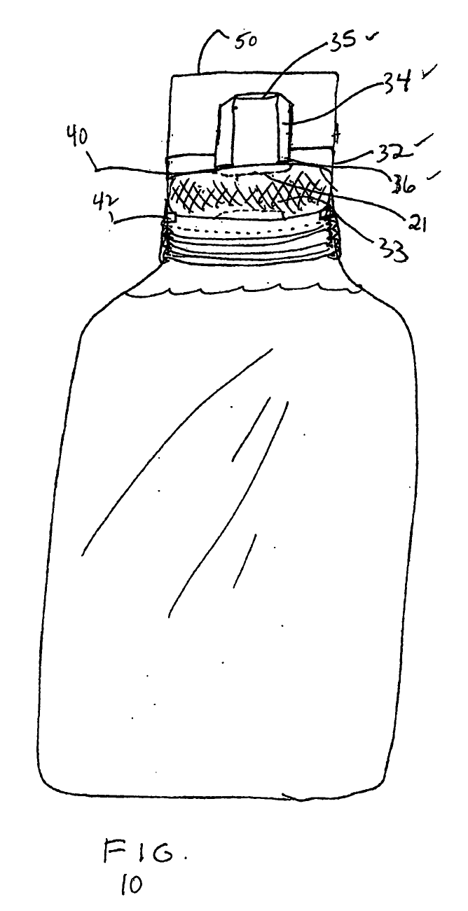

FIG. 12 shows a bottle cap 62 with an integral pump spray mechanism 64. The bottle cap 62 has a chamber 65 formed by a parseable member 66. The parseable member 66 can be a membrane, such as disclosed in FIGS. 1 to 5. The parseable membrane 66 can also be a bag, such as disclosed in FIGS. 7 to 11. Further, as previously described, the parseable membrane 66 can be perforated to make it easier to break the membrane or the bag.

The integral pump spray mechanism 64 includes a spray nozzle 68, a conduit 70 and a trigger device 72. When the trigger device 72 is squeezed, a vacuum is created in the hose 70, and whatever liquid is in the hose 70 is drawn up through the integral pump spray mechanism and expelled through the spray nozzle 68. The integral spray mechanism 64 forms a handle for a consumer to hold.

The bottle cap 62 has internal threads 74 which are adapted to receive the threads on a pre-existing fluid container, such as a water bottle. The parseable member 66 is connected to the bottle cap 62 so that when the bottle cap 62 is screwed onto a fluid container, the fluid container contacts the parseable member 66 to parse or break the member 66. The parseable member 66 can be attached to the bottle cap 62 by an adhesive or via a ring around the circumference of the member 66, as previously described. The parseable member 66 is also preferably secured to the conduit 70 via an adhesive or other means to create the chamber 65. The parable member 66 can be perforated, as previously described. The parseable member 66 is preferably located in the threaded area of the bottle cap 62 so that the fluid container can contact the parseable member 66 when the bottle cap 62 is placed on the container.

The parseable member 66 and the bottle cap 62 form a chamber 65 inside the bottle cap 62. The chamber 76 contains an ingredient 78 that is dispensed into a fluid container 80 when the bottle cap 62 is attached to the fluid container 80.

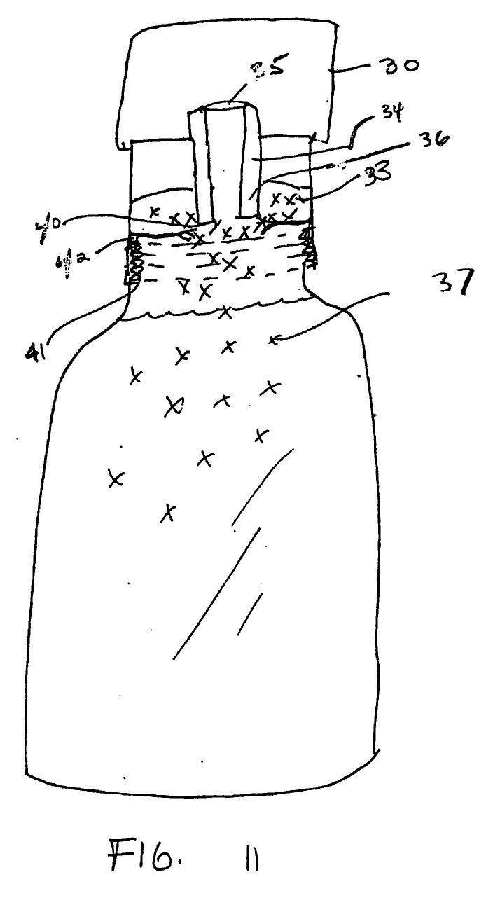

FIGS. 13 to 15 show a bottle cap with multiple chambers for dispensing multiple ingredients into a fluid container in accordance with one aspect of the present invention. In FIG. 13, a bottle cap 102 has a threaded section 106 to be able to be retrofitted onto a fluid container, such as a water bottle. The bottle cap 102 also has a parseable member 108. In this case, the parseable member 108 is a membrane. The membrane can be made of plastic, rubber or like material. A second membrane 110 is also provided in the bottle cap 102. The second membrane 110 is preferably perpendicular to the membrane 108 and is preferably attached to the sides and top of the bottle cap 102 and to the membrane 108 by an adhesive.

FIG. 14 illustrates a top down view of the bottle cap 102 of FIG. 13. As can clearly be seen, the second membrane 110 forms two chambers 112 and 114 in the bottle cap 102. A first ingredient 116 is held in the first chamber 112 and a second ingredient 118 is held in the second chamber 114. When the bottle cap 102 is placed on a fluid container, the membrane 108 is parsed or breaks, thereby releasing the ingredients 116 and 118 into the fluid container.

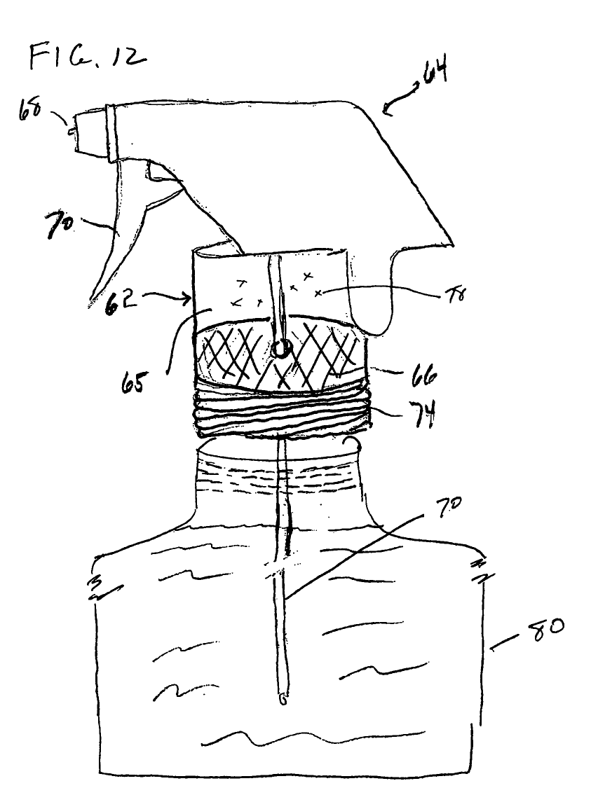

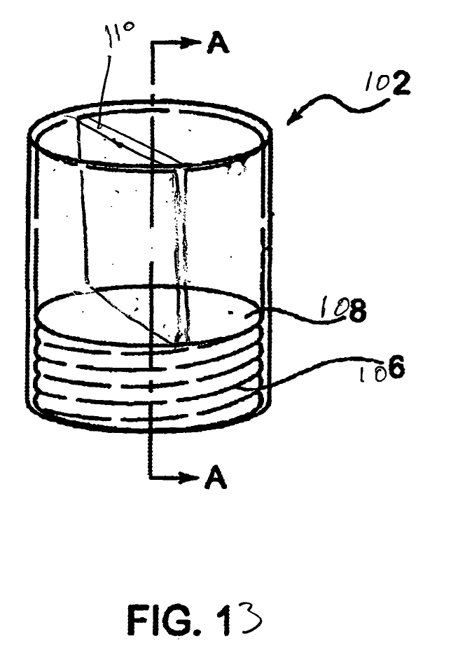

FIG. 15 illustrates a further aspect of the present invention. A bottle cap 120 has a membrane similar to membrane 108 in its bottom. The bottle cap 120 also has a first membrane 122, a second membrane 124 and a third membrane 126 that form three chambers 128, 129 and 130 in the bottle cap 120. The membranes 122, 124 and 126 are preferably secured to the bottle cap 120 and to each other via an adhesive. Chamber 128 hold a first ingredient 132. Chamber 129 holds a second ingredient 133. Chamber 130 holds a third ingredient 134. When the bottle cap 120 is attached to a fluid container, the parseable membrane in the bottom of the bottle cap 120 is parsed and each of the ingredients 132 to 134 are released into the fluid container. Of course, more chambers can be added to the bottle cap 120 by adding more membranes, if desired.

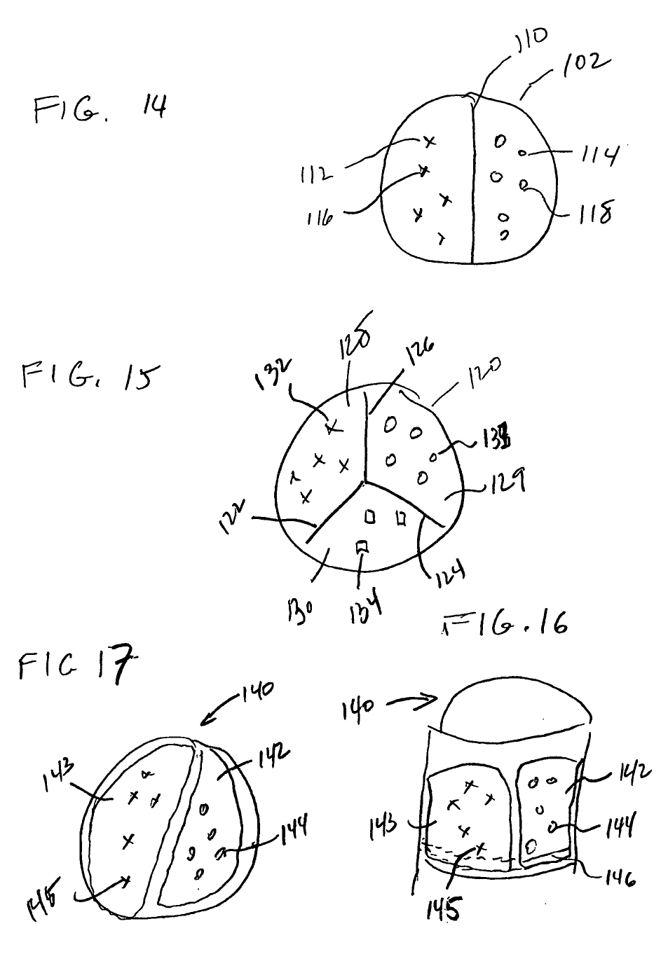

FIGS. 16 and 17 show a bottle cap 140 with multiple chambers for dispensing multiple ingredients into a fluid container in accordance with another aspect of the present invention. FIG. 17 is a top down view of the bottle cap 140 in FIG. 16.

The bottle cap 140 has a first parseable bag 142 and a second parseable bag 143. The parseable bags 142 and 143 are attached to the bottle cap 140 so that when the bottle cap 140 is retrofitted to a fluid container, the fluid container parses the bags 142 and 143. The attachment can be made via an adhesive. The bags 142 and 143 are preferably attached to the bottle cap 140 in the threaded area 146 of the bottle cap 140 so that the fluid container contacts the bags 142 and 143 upon retro-fitting to parse the bags 142 and 143. The bags 142 and 143 hold ingredients 144 and 145, respectively, which ingredients are released into a fluid container when the bottle cap 140 is attached to the fluid container. The ingredients can be released sequentially into the fluid container.

FIGS. 18 to 20 show a bottle cap with multiple chambers for dispensing multiple ingredients into a fluid container in accordance with a further aspect of the present invention. In FIG. 18, a bottle cap 150 has a device that has an open and closed position. A similar bottle cap has been previously described.

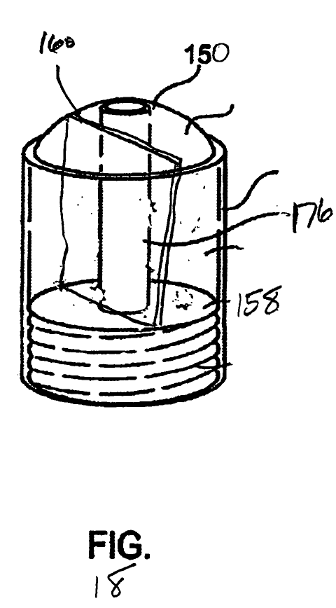

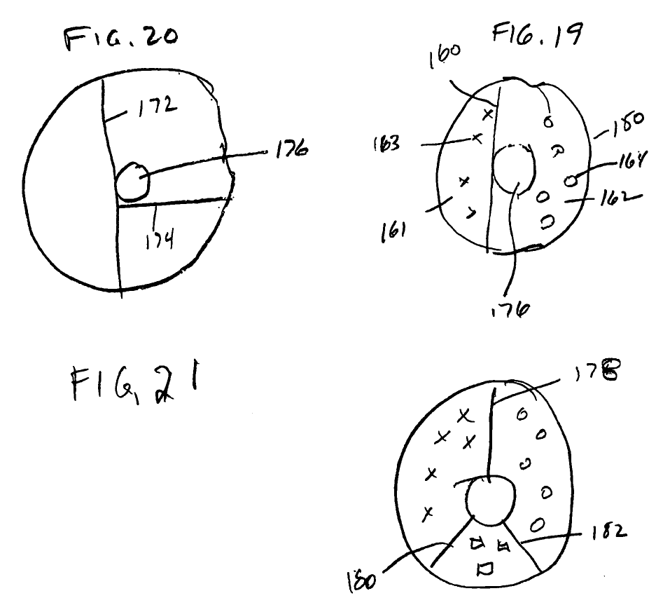

The bottle cap 150 has a membrane 158 attached to the bottle cap 150 in the threaded area 156 of the bottle cap 150 so that the membrane 158 is parsed to release the ingredients when a fluid container is attached to the bottle cap 150. As shown in FIG. 19, the bottle cap 150 also includes another membrane 160 attached to the sides and top of the bottle cap 150 and to the membrane 108 with an adhesive. The membrane 160 forms a first chamber 161 and a second chamber 162 that hold a first ingredient 163 and a second ingredient 164, respectively. When the membranes in the bottle cap 150 are parsed, the ingredients 163 and 164 are released into the fluid container that parsed the membranes. The two chambers in the bottle cap illustrated in FIG. 19 could also be formed with two perpendicular membranes, each being attached to the side of the bottle cap and to the drinking apparatus 176 via adhesive or other means.

FIGS. 20 and 21 show a bottle cap having three chambers. In FIG. 20, wherein a first membrane is positioned in the bottom of the bottle cap so as to be parsed when the bottle cap is attached to a fluid container. A second membrane 172 and a third membrane 174 are attached as illustrated, with adhesive or other attachment means, to for three chambers in the bottle cap.

FIG. 21 illustrates the formation of three chambers in a bottle cap 180 using three perpendicular membranes 178, 180 and 182.

The bottle cap 150 can also form multiple chambers by using two or more parseable bags, as previously illustrated and described. The parseable bags are attached near the threaded area of the bottle cap 150 so that a fluid container, upon attachment to the bottle cap 150, parses the bags to release multiple ingredients into the fluid container.

While there have been shown, described and pointed out fundamental novel features of the invention as applied to preferred embodiments thereof, it will be understood that various omissions and substitutions and changes in the form and details of the device illustrated and in its operation may be made by those skilled in the art without departing from the spirit of the invention. It is the intention, therefore, to be limited only as indicated by the scope of the claims appended hereto.

1. A bottle cap for universal retrofitting to one of a number of pre-existing fluid containers containing a fluid and having a removed cap and aperture, said cap comprising:
(a) a first chamber;
(b) an attachment for receiving the aperture and creating, when twisted, a water-tight assembly; and
(c) the first chamber having a first parseable member and containing a first dispensable material, wherein upon attachment of the aperture onto said attachment the first parseable member becomes parsed to permit feeding of said first dispensable material into the fluid.

2. The universal bottle cap as claimed in claim 1, further comprising a pump mechanism with a pump and a conduit that extends through the attachment, wherein when the bottle cap receives the aperture, the conduit extends into the fluid container and into the fluid.

3. The universal bottle cap as claimed in claim 1, further comprising a second chamber, the second chamber having a second parseable member and containing a second dispensable material, wherein upon attachment of the aperture onto said attachment the second parseable member becomes parsed to permit feeding of said second dispensable material into the fluid.

4. The universal bottle cap as claimed in claim 3, further comprising a third chamber, the third chamber having a third parseable member and containing a third dispensable material, wherein upon attachment of the aperture onto said attachment the third parseable member becomes parsed to permit feeding of said third dispensable material into the fluid.

5. The universal bottle cap as claimed in claim 1, wherein the first dispensable material is a fluid.

6. The universal bottle cap as claimed in claim 1, wherein the first dispensable material is a powder.

7. The universal bottle cap as claimed in claim 1, wherein the first dispensable material is a flavored powder and the fluid is water.

8. The universal bottle cap as claimed in claim 1, wherein the first dispensable material is a liquor.

9. The universal bottle cap as claimed in claim 3, wherein the first dispensable material is a first liquor and the second dispensable material is a second liquor.

10. The universal bottle cap as claimed in claim 1, wherein the first dispensable material is a pharmaceutically active agent.

11. The universal bottle cap as claimed in claim 1, wherein the first dispensable material is a cleaning agent.

12. The universal bottle cap as claimed in claim 2, wherein the first dispensable material is a cleaning agent.

13. The universal bottle cap as claimed in claim 1, wherein the first dispensable material is a powdered formula for babies.

14. The universal bottle cap of claim 1, wherein a plurality of such bottle caps are packaged for commercial sale.

15. The universal bottle cap of claim 2, wherein a plurality of such bottle caps are packaged for commercial sale.

16. The universal bottle cap of claim 3, wherein a plurality of such bottle caps are packaged for commercial sale.

17. The universal bottle cap of claim 3, wherein the first parseable member and the second parseable members are perforated to facilitate tearing.

18. The universal bottle cap of claim 1, wherein the first parseable member and the second parseable member are securely attached to the bottle cap via an adhesive.

19. The universal bottle cap of claim 1, wherein the parseable member is supported in the bottle cap by a ring connected to the cap, said parseable resting on the ring.

20. The universal bottle cap of claim 1, wherein the parseable member is a membrane.

21. The universal bottle cap of claim 1, wherein the parseable member is a bag.

22. A bottle cap for universal retrofitting to one of a number of pre-existing fluid containers containing a beverage and having a removed cap and aperture, comprising:
(a) a first chamber;
(b) an attachment for receiving the aperture and creating, when attached, a water-tight assembly; and
(c) the first chamber having a first parseable member and containing a first dispensable material, and
(d) a moveable aperture assembly creating an open, fluid-flowing state and a closed, fluid-stopped state, having a top portion containing a drinking aperture and an elongated, moveable fluid-flowing portion, wherein moving the assembly causes the assembly to parse the parseable member and release the first dispensable material into the fluid container.

23. The universal bottle cap as claimed in claim 22, further comprising a second chamber, the second chamber having a second parseable member and containing a second dispensable material, wherein upon moving the assembly the second parseable member becomes parsed to permit feeding of said second dispensable material into the fluid.

24. The universal bottle cap as claimed in claim 23, further comprising a third chamber, the third chamber having a third parseable member and containing a third dispensable material, wherein upon moving the assembly the third parseable member becomes parsed to permit feeding of said third dispensable material into the fluid.

25. The universal bottle cap as claimed in claim 22, wherein the first dispensable material is a fluid.

26. The universal bottle cap as claimed in claim 22, wherein the first dispensable material is a powder.

27. The universal bottle cap as claimed in claim 22, wherein the first dispensable material is a flavored powder and the fluid is water.

28. The universal bottle cap as claimed in claim 22, wherein the first dispensable material is a liquor.

29. The universal bottle cap as claimed in claim 23, wherein the first dispensable material is a first liquor and the second dispensable material is a second liquor.

30. The universal bottle cap as claimed in claim 22, wherein the first dispensable material is a pharmaceutically active agent.

31. The universal bottle cap as claimed in claim 22, wherein the first dispensable material is a cleaning agent.

32. The universal bottle cap of claim 22, wherein a plurality of such bottle caps are packaged for commercial sale.

33. The universal bottle cap of claim 23, wherein the first parseable member and the second parseable member are perforated to facilitate tearing.

34. The universal bottle cap of claim 23, wherein the first parseable member and the second parseable member are securely attached to the bottle cap via an adhesive.

35. The universal bottle cap of claim 23, wherein the first parseable member and the second parseable member are supported in the bottle cap by a ring connected to the cap.

36. The universal bottle cap of claim 23, wherein the first parseable member and the second parseable member are membranes.

37. The universal bottle cap of claim 23, wherein the first parseable member and the second parseable member are bags.
